(19) United States
(12) Patent Application Publication
(10) Pub. No.: US 2011/0194748 A1
(43) Pub. Date: Aug. 11, 2011

(54) ULTRASONIC DIAGNOSTIC APPARATUS AND ULTRASONIC IMAGE DISPLAY METHOD

(76) Inventors: Akiko Tonomura, Tokyo (JP); Takashi Iimura, Tokyo (JP)

(21) Appl. No.: 13/123,289

(22) PCT Filed: Oct. 13, 2009
(86) PCT No.: PCT/JP2009/067696

§ 371 Date: Apr. 8, 2011

(30) Foreign Application Priority Data
Oct. 14, 2008 (JP) 2008264719

(51) Int. Cl. G06K 9/00

(52) U.S. Cl. 382/131

(57) ABSTRACT

In order to provide an ultrasonic diagnostic apparatus and an ultrasonic image display method for recognizing a region (boundary portion) having elasticity information of interest, an ultrasonic diagnostic apparatus having an elasticity information calculating unit 10 for calculating elasticity information containing distortion or an elasticity modulus on the basis of RF signal frame data based on a reflection echo signal received through an ultrasonic probe 1, an elasticity mage constructing unit 12 for constructing an elasticity image on the basis of the elasticity information obtained by the elasticity information calculating unit 10, a tomographic image constructing unit 6 for constructing a tomographic image on the basis of the RF signal frame data, and an image display unit 15 for displaying one or both of the tomographic image and the elasticity image is provided with a histogram calculating unit 111 for creating histogram data based on the elasticity information and the frequency, and a boundary detecting unit 112 for detecting a boundary portion of a peripheral edge of a region-of-interest set on the basis of a predetermined range of the elasticity information of the histogram data, and the image display unit 15 displays the boundary portion.

### FIELD OF THE INVENTION

The present invention relates to an ultrasonic diagnostic apparatus and an ultrasonic image display method for obtaining a tomographic image of a diagnosis site in an object by using ultrasonic waves, and particularly to an ultrasonic diagnostic apparatus and an ultrasonic image display method for calculating distortion and/or elasticity modulus from RF signal frame data to display an elasticity image representing hardness or softness of a living body tissue.

### BACKGROUND ART

The ultrasonic diagnostic apparatus transmits ultrasonic waves into an object by an ultrasonic probe, and constructs and displays a tomographic image on the basis of a reception signal received from a living body tissue in the object, for example. Furthermore, a reception signal received from the living body tissue in the object is measured by the ultrasonic probe, and a displacement of each part of a living body is determined from two RF signal frame data different in measurement time. Then, an elasticity image representing the elasticity modulus of the living body tissue is constructed from the elasticity frame data based on the displacement data. The elasticity image is suitable for detecting a harder portion or softer portion than peripheral tissues in the living body tissue. The tomographic image images the difference in acoustic impedance of the living body tissue, and suitable for observing the structure or figuration of a tissue from the difference in brightness value or the roughness in speckle. By using both the information of the elasticity image and the tomographic image, it is possible to know the difference in hardness and shape of the tissue, the internal structure of the tissue, etc., and more minute information can be obtained.

Furthermore, it is displayed which region of an elasticity image a measurement point in a range set in a histogram determined on the basis of elasticity frame data corresponds to. (For example, Patent Document 1).

### PRIOR ART DOCUMENT

### Patent Document

Patent Document 1: International Publication No. WO2007/046272

### SUMMARY OF THE INVENTION

### Problem to be Solved by the Invention

However, when it is merely displayed which region of the elasticity image the measurement point set within the range set in the histogram corresponds to, it would be difficult to check the relationship with the tomographic image. This is because a method of displaying a tomographic image and an elasticity image while arranging them side by side requires movement of a visual line from the elasticity image to the tomographic image, and thus it is difficult to recognize the positional relationship. Furthermore, a method of displaying a tomographic image and an elasticity image while they are superimposed on each other does not require movement of the visual line. However, in order to minutely observe a speckle of the inside of the tomographic image, it is required to change the superimposition rate of the tomographic image and the elasticity image.

In order to solve the above problem, there is provided an ultrasonic diagnostic apparatus and an ultrasonic image display method that can recognize a region (boundary portion) having elasticity information of interest.

### Means for Solving the Problem

In order to solve the above problem, the present invention has the following construction.

A histogram based on a frequency of elasticity information (distortion, elasticity modulus, viscosity, Poisson's ratio, etc.) is determined, a boundary portion at a peripheral edge of a region of interest set on the basis of a predetermined range of elasticity information is detected, and the boundary portion is displayed. Accordingly, an examiner can minutely observe a state of a speckle, a shading state, etc. in the boundary portion. Furthermore, an image display portion displays the boundary portion on a tomographic image or an elasticity image.

### Effect of the Invention

According to this invention, a region having elasticity information of interest (boundary portion) can be recognized.

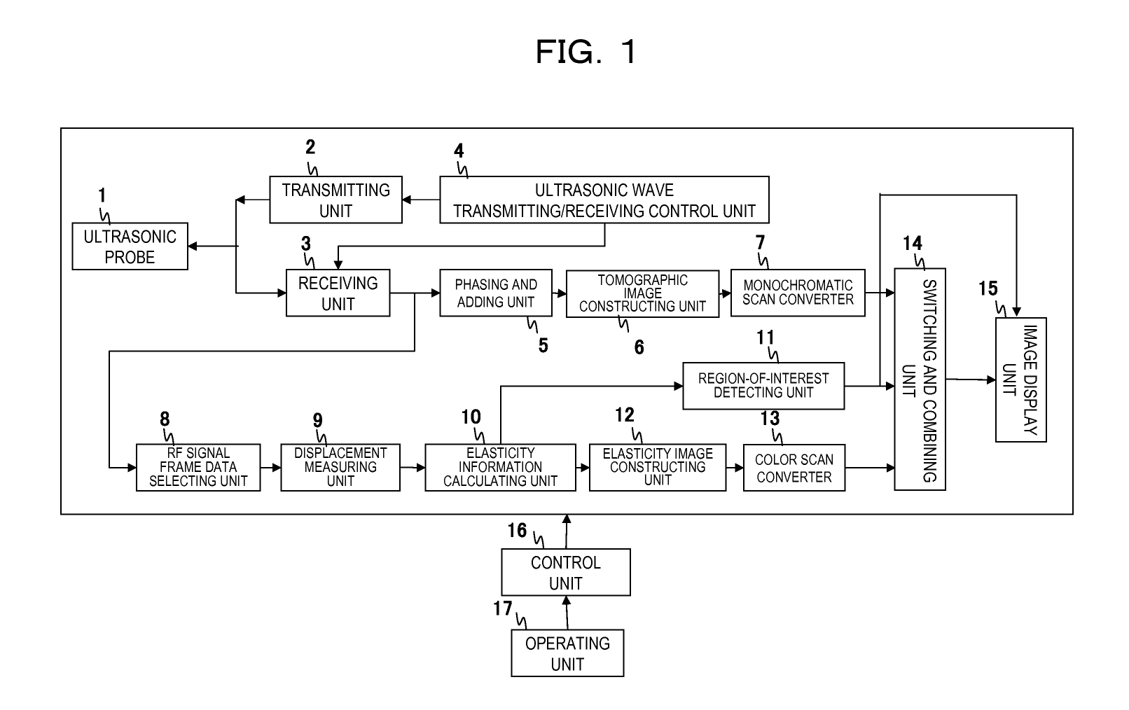

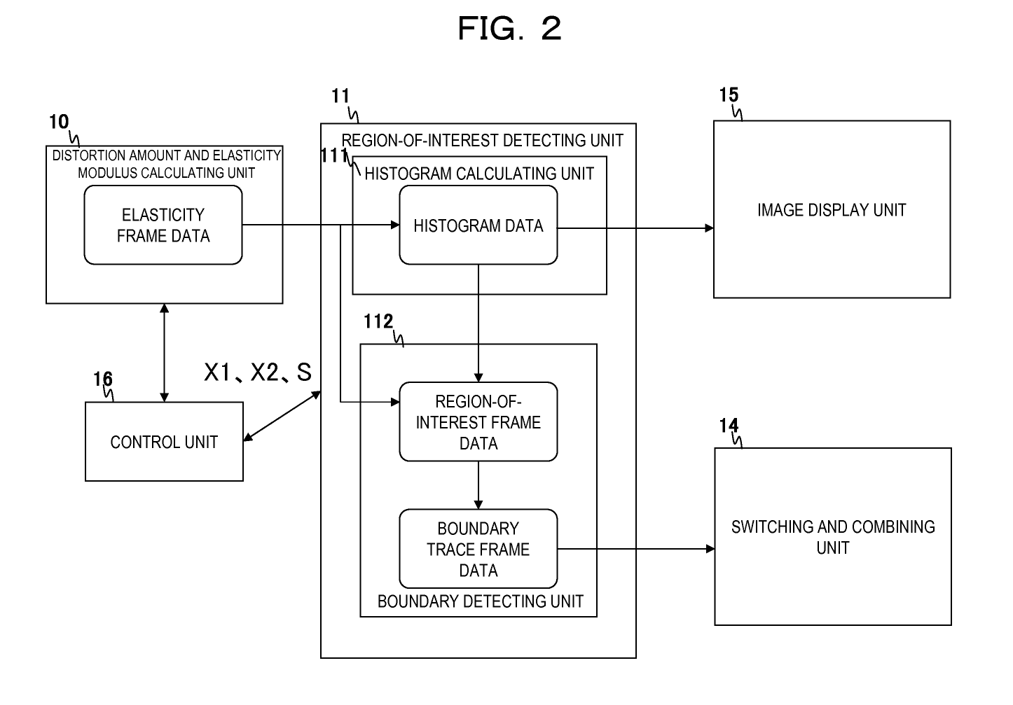

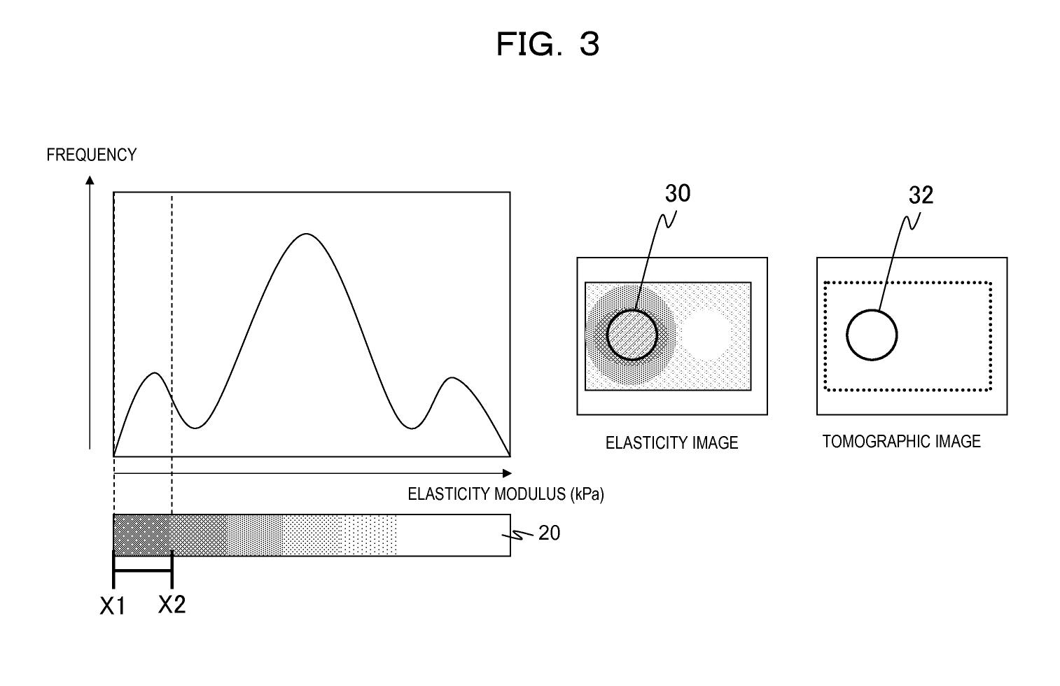

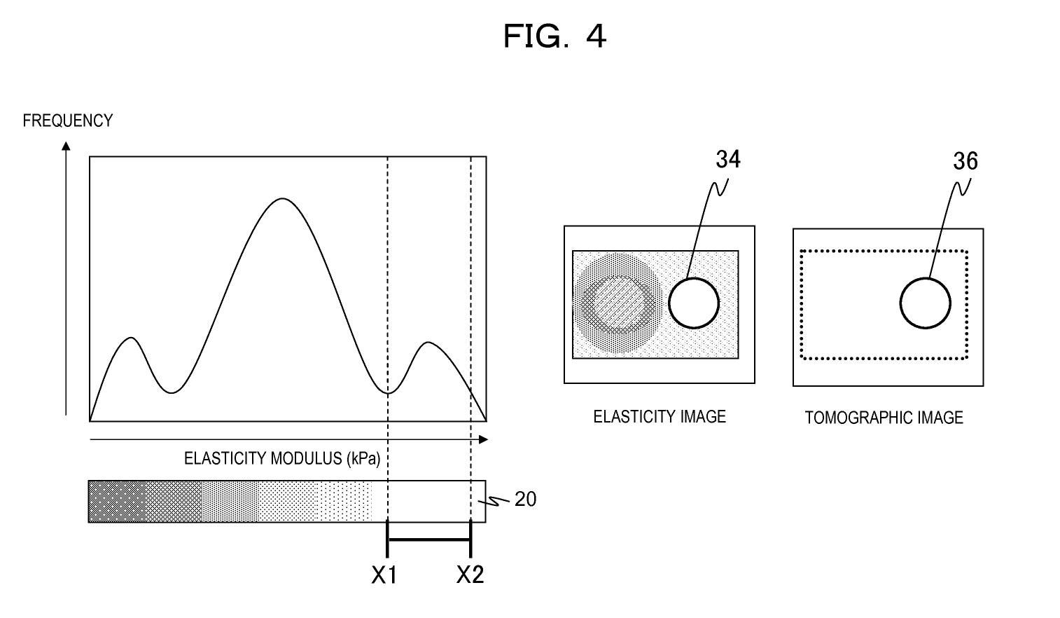

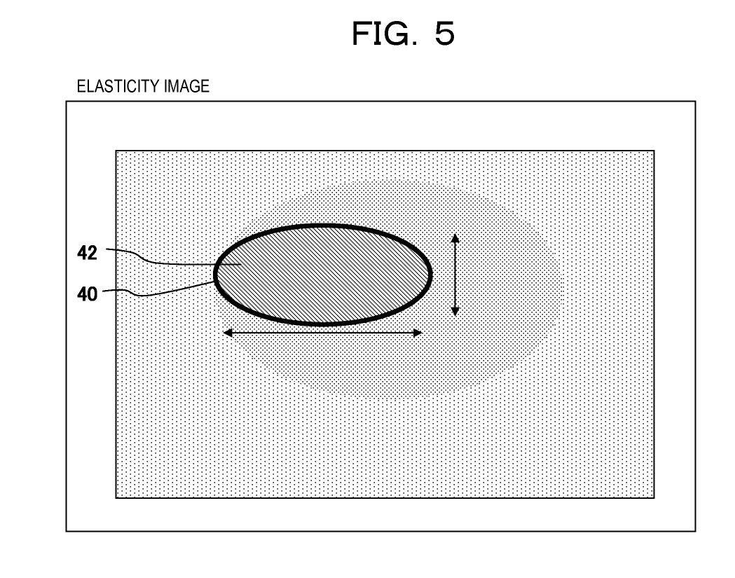

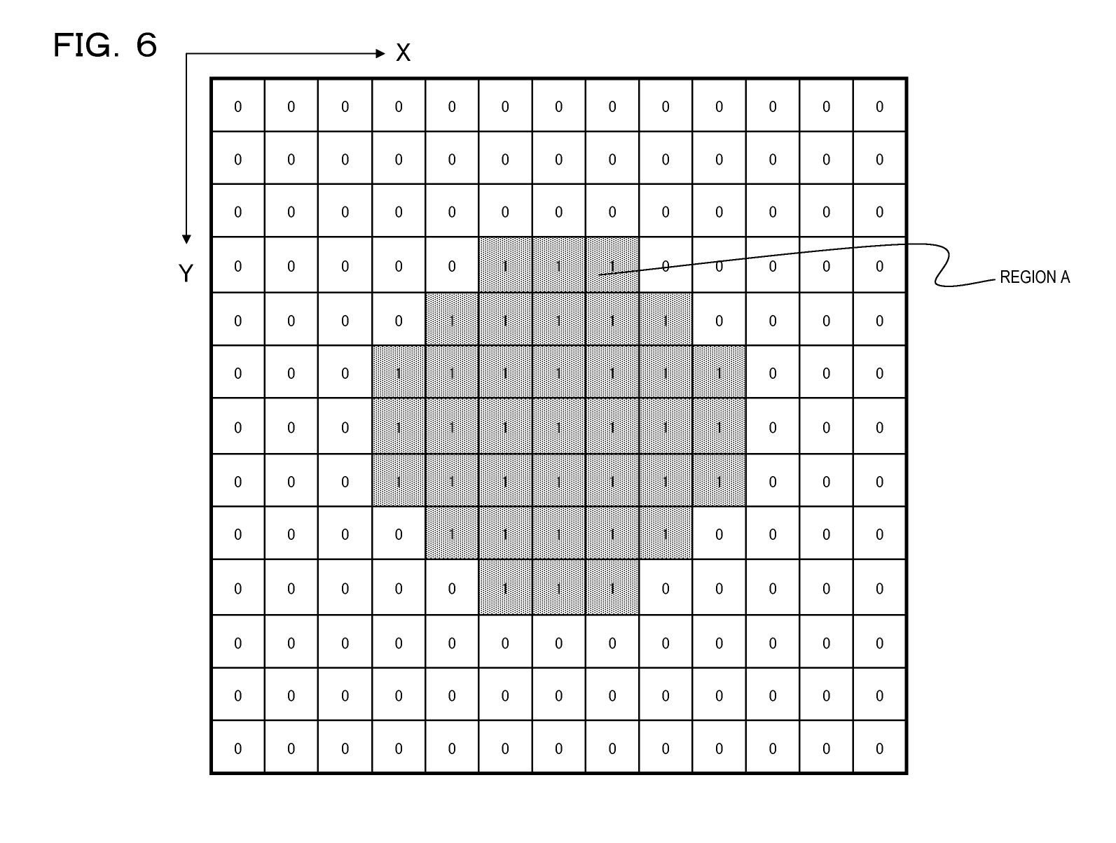

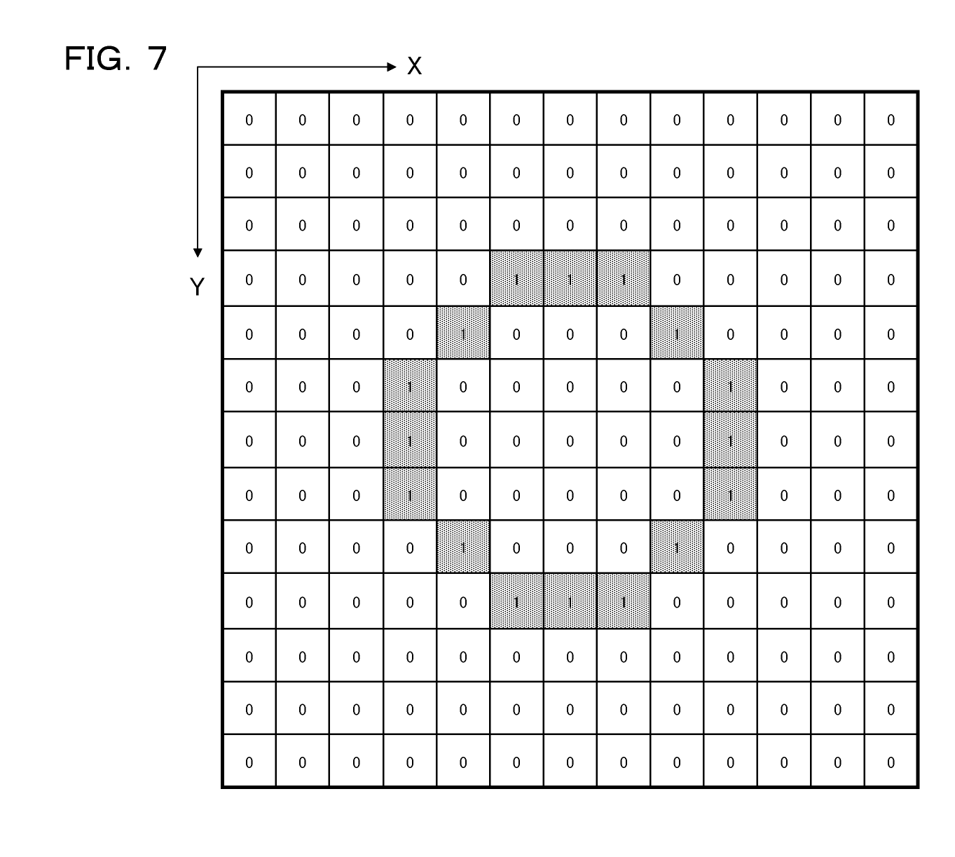

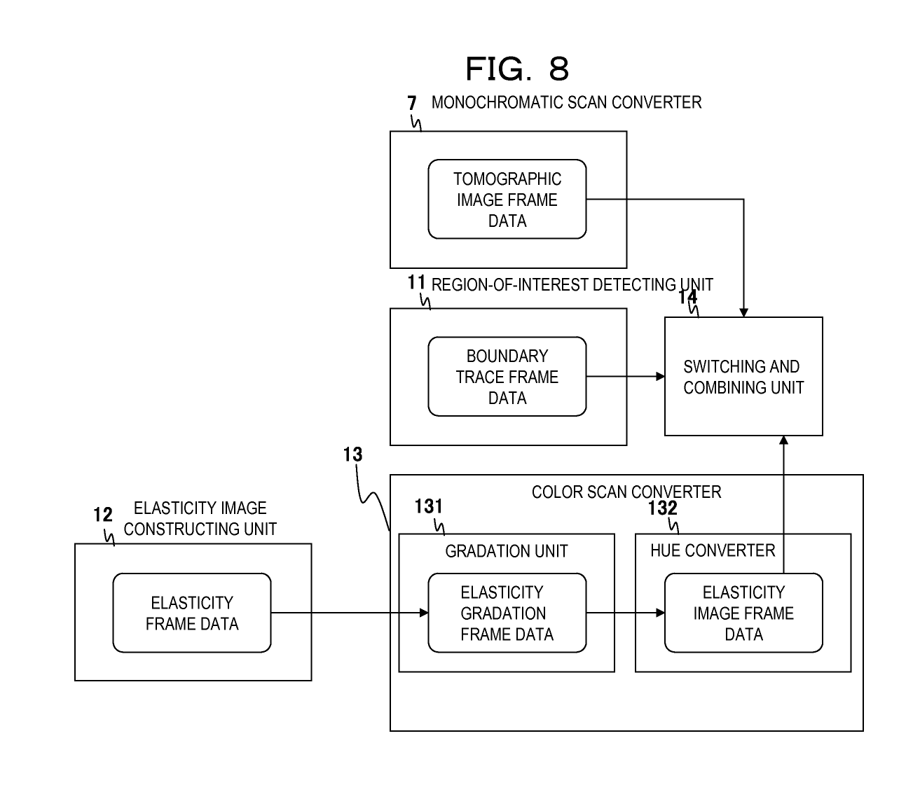

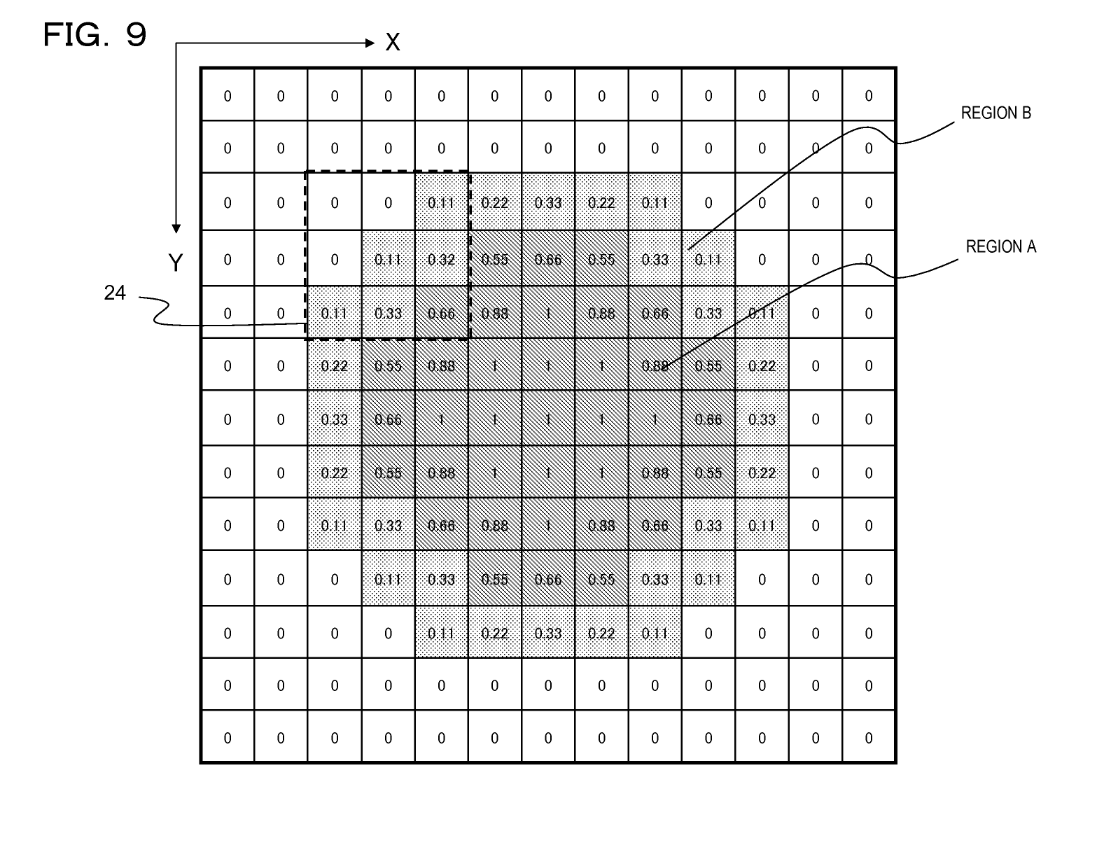

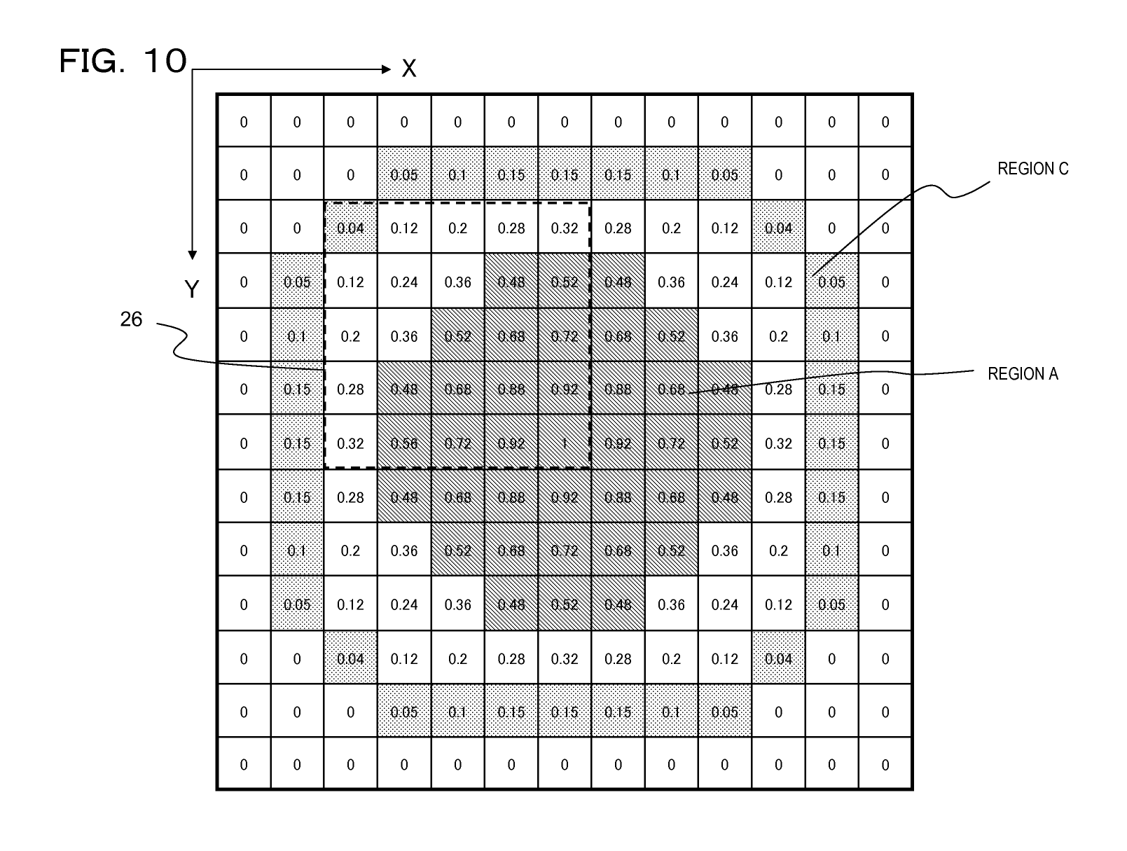

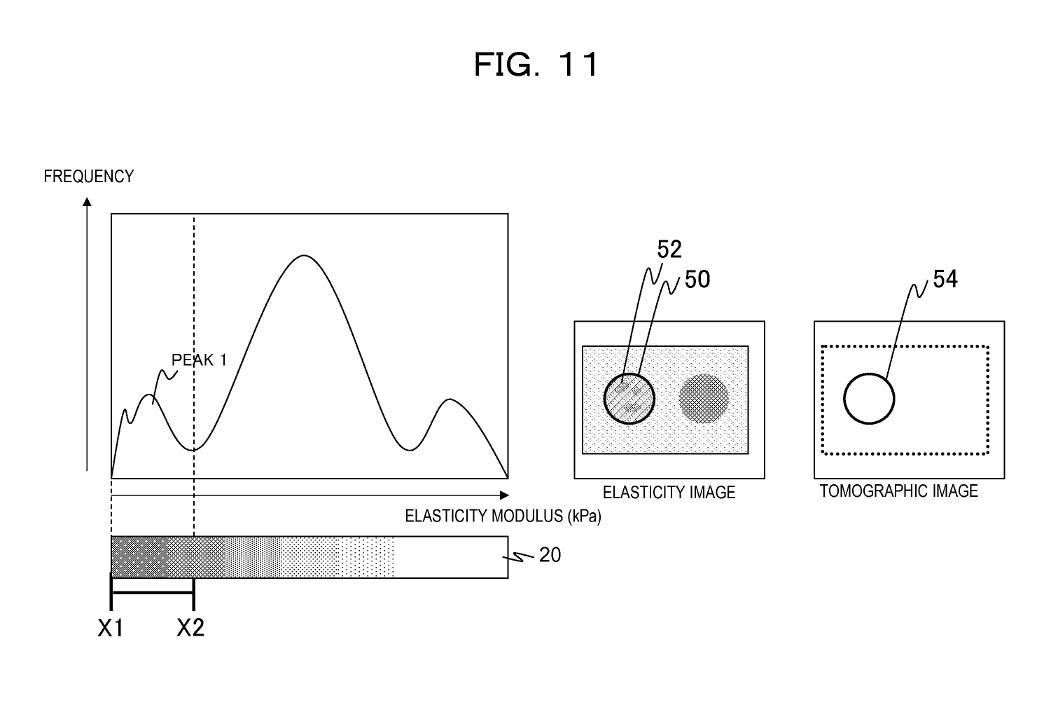

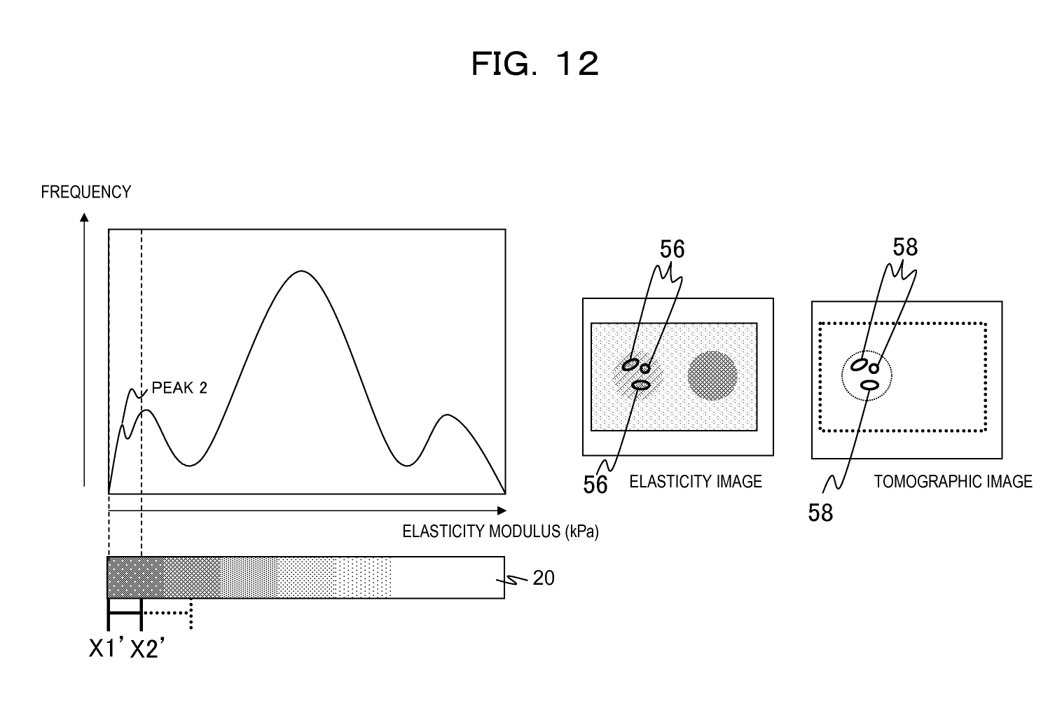

### BRIEF DESCRIPTION OF THE DRAWINGS

[FIG. 1] is a block diagram showing the overall construction of an ultrasonic diagnostic apparatus according to each embodiment of the present invention.

[FIG. 2] is a diagram showing an embodiment of a region-of-interest detecting unit according to the present invention.

[FIG. 3] is a diagram showing a display style according to the present invention.

[FIG. 4] is a diagram showing a display style according to the present invention.

[FIG. 5] is a diagram showing a style of selecting a region on an elasticity image according to the present invention.

[FIG. 6] is a diagram showing a region-of-interest frame data according to the present invention.

[FIG. 7] is a diagram showing boundary trace frame data according to the present invention.

[FIG. 8] is a diagram showing a color scan converter and a switching and combining unit according to the present invention.

[FIG. 9] is a diagram showing a third embodiment according to the present invention.

[FIG. 10] is a diagram showing the third embodiment according to the present invention.

[FIG. 11] is a diagram showing a fourth embodiment according to the present invention.

[FIG. 12] is a diagram showing the fourth embodiment according to the present invention.

### MODES FOR CARRYING OUT THE INVENTION

### First Embodiment

An embodiment according to the present invention will be described with reference to the drawings. FIG. 1 is a block diagram showing an ultrasonic diagnostic apparatus according to the present invention. The ultrasonic diagnostic apparatus obtains a tomographic image for a diagnosis site of an object by using ultrasonic waves, and displays an elasticity image representing hardness or softness of a living body tissue.

The ultrasonic diagnostic apparatus has an ultrasonic probe 1 used in contact with an object, a transmitting unit 2 for repetitively transmitting ultrasonic waves through the ultrasonic probe 1 to the object at a time interval, a receiving unit 3 for receiving time-series reflection echo signals occurring from the object, an ultrasonic wave transmitting/receiving control unit 4 for controlling the switching operation between transmission and reception of the transmitting unit 2 and the receiving unit 3, a phasing and adding unit 5 for phasing and adding the reflection echo signals received by the receiving unit 3, a tomographic image constructing unit 6 for acquiring tomographic image frame data from RF signal frame data from the phasing and adding unit 5, and a monochromatic scan converter 7 for performing coordinate-system conversion of the tomographic image frame data.

Furthermore, the ultrasonic diagnostic apparatus has an RF signal frame data selecting unit 8 for selecting at least two RF signal frame data, a displacement measuring unit 9 for measuring a displacement of a living body tissue of the object from the at least two selected RF signal frame data, an elasticity information calculating unit 10 for acquiring elasticity information such as distortion, an elasticity modulus or the like from the displacement information measured in the displacement measuring unit 9, an elasticity image constructing unit 12 for constructing elasticity image frame data from the distortion or the elasticity modulus, a color scan converter 13 for performing gradation and coloring on the elasticity image frame data, a region-of-interest detecting unit 11 for detecting a region of interest by using histogram data of the elasticity information such as the distortion, the elasticity modulus or the like, a switching and combining unit for combining the tomographic image frame data, the elasticity image frame data and the like, displaying them side by side and switching them, an image display unit 15 for displaying a tomographic image, an elasticity image and a composite image obtained by combining the tomographic image and the elasticity image, a control unit 16 for controlling the above respective constituent elements, and an operating unit 17 for transmitting an examiner's instruction to the control unit 16. The ultrasonic diagnostic apparatus is arbitrarily operated through the operating unit 17 and the control unit 16.

The ultrasonic probe 1 is constructed by arranging, like a strip, many transducers which serve as ultrasonic wave generating sources and receiving reflection echoes. The transducers are subjected to mechanical or electrical beam scanning to transmit and receive ultrasonic waves to and from the object. In general, the transducer has a function of converting a transmission signal of an input pulse wave or continuous wave to an ultrasonic wave and emitting the ultrasonic wave, and a function of receiving an ultrasonic wave emitted from the inside of the object, converting the ultrasonic wave to a reception signal of an electrical signal and outputting the reception signal.

With respect to the operation of pressing the object by elasticity using ultrasonic waves, it is general to apply a stress distribution to a diagnosis site of the object while ultrasonic waves are transmitted/received by the ultrasonic probe 1. Specifically, a press plate is mounted so as to be fitted to an ultrasonic wave transmission/reception face of the ultrasonic probe 1, and the press face including the ultrasonic wave transmission/reception face of the ultrasonic probe 1 and the press plate is manually moved in the up-and-down direction to press the object.

The ultrasonic wave transmission/reception control unit 4 controls transmission and reception timings of ultrasonic waves. The transmitting unit 2 generates a wave-transmission pulse for generating ultrasonic waves by driving the ultrasonic probe 1, and also sets the convergence point of ultrasonic waves to be transmitted to some depth. The receiving unit 3 amplifies a reception signal received by the ultrasonic probe 1 at a predetermined gain. Amplified reception signals whose number corresponds to the number of the transducers are respectively input as independent reception signals to the phasing and adding unit 5.

The phasing and adding unit 5 controls the phase of the reception signal amplified in the receiving unit 3, and forms ultrasonic beams for one or plural convergence points. The tomographic image constructing unit 6 receives a reception signal from the phasing and adding unit 5, and executes various kinds of signal processing such as gain correction, log correction, wave detection, edge enhancement, filter processing, etc. to construct tomographic image frame data. The monochromatic scan converter 7 controls to read out the tomographic image frame data output from the tomographic image constructing unit 6 at a television system period to display thereof on the image display unit 15.

The RF signal frame data selecting unit 8 serves to successively store, into a frame memory provided to the RF signal frame data selecting unit 8, RF signal frame data which are output from the phasing and adding unit 5 in time-series at the frame rate of the ultrasonic diagnostic apparatus (the currently stored RF signal frame data is called as RF signal frame data N), selects one RF signal frame data (this frame data is called as RF signal frame data X) from timely-past RF signal frame data N-1, N-2, N-3, . . . , N-M according to a control command of the ultrasonic diagnostic apparatus, and output a pair of RF signal frame data N and RF signal frame data X to the displacement measuring unit 9. The signal output from the phasing and adding unit 5 is referred to as the RF signal frame data, however, it may be a signal based on I, Q signal type which is obtained by subjecting an RF signal to composite demodulation, for example.

The displacement measuring unit 9 executes one-dimensional or two-dimensional correlation processing on the basis of a pair of RF signal frame data selected by the RF signal frame data selecting unit 8 and the displacement or moving vector (the direction and magnitude of the displacement) at each measurement point on a tomographic image is measured to generate displacement frame data. A block matching method described in JP-A-5-317313 or the like is known as a method of detecting this moving vector. According to the block matching method, an image is divided into blocks each including N×N pixels, for example, a block which is most approximate to a block of interest in a present frame is searched from a previous frame, and predictive coding is performed by referring to these blocks.

The elasticity information calculating unit 10 calculates the distortion or the elasticity modulus (elasticity information) at each measurement point on the tomographic image from the displacement frame data output from the displacement measuring unit 9 to generate numerical value data (elasticity frame data) thereof, and outputs the numerical value data to the region-of-interest detecting unit 11 and the color scan converter 12. The elasticity information contains not only the distortion or the elasticity modulus, but also viscosity, Poisson ratio, etc. With respect to the distortion calculation executed in the elasticity information calculating unit 10, it is assumed that the distortion is calculated by spatially differentiating the displacement, for example. Furthermore, with respect to the calculation of Young's modulus Ym which is a kind of elasticity modulus, it is determined by dividing the stress (pressure) at each calculation point by the distortion at each calculation point as shown in the following mathematical expression.

In the following mathematical expression, the indexes, i,j represent the coordinate of the frame data.

Ymi, j=pressure (stress) i, j/(distortion i, j) (i, j=1, 2, 3, . . . ) [Expression 1]

Here, a pressure sensor (not shown) is interposed at the contact face between the body surface and the press mechanism, and the pressure applied to the body surface is directly measured by this pressure sensor. Furthermore, a pressure measuring deformable body (not shown) is provided so as to cover the transmission/reception face of ultrasonic waves, and the pressure applied to the body surface of a diagnosis site which is pressed by the ultrasonic probe 1 may be measured from the deformation state of the deformable body.

As shown in FIG. 2, the region-of-interest detecting unit 11 includes a histogram calculating unit 111 and a boundary detecting unit 112. The histogram calculating unit 111 counts the numerical value of elasticity information such as the distortion or elasticity modulus at each coordinate of the elasticity frame data output from the elasticity information calculating unit 10, and calculates histogram data on the basis of the frequency to the numerical value. The histogram data calculated in the histogram calculating unit 111 is displayed on the image display unit 15.

The display style of the histogram data displayed on the image display unit 15 is shown in FIGS. 3 and 4. The ordinate axis of the histogram data shown in FIGS. 3 and 4 represents the frequency, and the abscissa axis represents the elasticity modulus. In this embodiment, the abscissa axis represents the elasticity modulus, however, it may represent distortion, viscosity, Poisson ratio or the like. Furthermore, a color bar 20 is an index for associating the distortion or elasticity modulus (elasticity information) with the hue of an elasticity image, and it is cooperated with the color scan converter 13. For example, the hue is set by using the color bar 20 so that a site having smaller distortion or larger elasticity modulus (for example, 300 kPa or more) than the surrounding region is colored with blue or a site having larger distortion or smaller elasticity modulus (for example, 100 kPa or less) than the surrounding region is colored with red.

An examiner arbitrarily specifies a lower limit value X1 and a upper limit value X2 of a boundary tracing range for the histogram data by using the operating unit 17. For example, when a soft site is required to be extracted, the lower limit value X1 and the upper limit value X2 are set to a small elasticity-modulus side as shown in FIG. 3, and when a hard site is required to be extracted, the lower limit value X1 and the upper limit value X2 are set to a large elasticity-modulus side as shown in FIG. 4.

Furthermore, the examiner may select a region on an elasticity image having distortion or elasticity modulus (elasticity information) of interest to specify the lower limit value X1 and the upper limit value X2. Specifically, a region 40 on the elasticity image displayed on the image display unit 15 is selected by the operating unit 17 as shown in FIG. 5. The region 40 can be arbitrarily deformed in the direction of an arrow by the operating unit 17. The control unit 16 sets the lower limit value X1 and the upper limit value X2 on the basis of the minimum value and the maximum value of the distortion or the elasticity modulus (elasticity information) at respective coordinates 42 in the selected region 40 in the elasticity frame data output from the elasticity information calculating unit 10. In this case, the minimum value corresponds to the lower limit value X1, and the maximum value corresponds to the upper limit value X2. The control unit 16 sets the lower limit value X1 and the upper limit value X2 for the histogram data calculated in the histogram calculating unit 111.

By using the lower limit value X1 and the upper limit value X2 specified as described above, the boundary detecting unit 112 creates region-of-interest frame data and boundary trace frame data for tracing the corresponding region.

The boundary detecting unit 112 first extracts a region having distortion or elasticity modulus (elasticity information) corresponding to the range from the lower limit value X1 to the upper limit value X2 from the elasticity frame data output from the elasticity information calculating unit 10, and creates the region-of-interest frame data. The created region-of-interest frame data is shown in FIG. 6. “1” is input to the areas whose distortion or elasticity modulus (elasticity information) corresponds to the range from the lower limit value X1 to the upper limit value X2 (region A), and “0” is input to areas whose distortion or elasticity modulus (elasticity information) does not correspond to the range from the lower limit value X1 to the upper limit value X2 (region other than the region A), thereby creating the region-of-interest frame data.

With respect to the region A formed by linking the corresponding areas, the control unit 16 may calculate feature quantities of the region A, for example, the average value, standard deviation, area, complexity defined by the following mathematical expression, etc. of the distortion or elasticity modulus in the region A, and display them on the image display unit 15.

Complexity=(boundary length)2/area [Expression 2]

Next, the boundary detecting unit 112 creates boundary trace frame data which extracts the boundary portion of the peripheral edge of the region A extracted on the basis of the region-of-interest frame data. The created boundary trace frame data is shown in FIG. 7. The boundary detecting unit 112 extracts the boundary portion of the peripheral edge of “1” as the region (region A) of the distortion or elasticity modulus (elasticity information) corresponding to the range from the lower limit value X1 to the upper limit value X2 of the region-of-interest frame data. “1” is input to the extracted boundary and “0” is input to the other region, thereby creating the boundary trace frame data.

The boundary detecting unit 112 may extract a boundary portion to create the boundary trace frame data by a contour extracting method using elasticity frame data output from the elasticity information calculating unit 10, for example, first derivation, second derivation or the like without using a method of specifying the lower limit value X1 and the upper limit value X2 and creating the boundary trace frame data from the region-of-interest frame data. Furthermore, the boundary detecting unit 112 may set “0” for all the boundary trace frame data when it is unnecessary to trace the boundary portion.

Furthermore, the elasticity image constructing unit 12 subjects the calculated elasticity frame data to various image processing such as smoothing processing within the coordinate plane, smoothing processing in the time-axis direction between frames, etc., and outputs the processed elasticity frame data.

As shown in FIG. 8, the color scan converter 13 includes a gradation unit 131 and a hue converter 132. A lower limit value Y1 and an upper limit value Y2 for a gradation selecting range in the elasticity frame data output from the elasticity image constructing unit 12 are specified by the operating unit 17. The gradation unit 131 gradates the elasticity frame data in the range between the specified lower limit value Y1 and upper limit value Y2 to create elasticity gradation frame data. For a site having smaller distortion or a larger elasticity modulus than the surrounding region, the hue converter 132 converts the corresponding region to a red code in the elasticity gradation frame data. Conversely, for a site having large distortion or a smaller elasticity modulus than the surrounding region, the hue converter 132 converts the corresponding region to a blue code. Furthermore, in the case of the other regions, the hue converter 132 converts these regions to black color. Furthermore, the color scan converter 13 controls to read out the elasticity image frame data hue-converted in the hue converter 132 at a television system period.

The color scan converter 13 may be the monochromatic scan converter 7. The monochromatic scan converter 7 may increase the brightness of the corresponding region in the elasticity image frame data for the site having smaller distortion or a larger elasticity modulus than the surrounding region and conversely reduce the brightness of the corresponding region in the elasticity image frame data for the site having larger distortion or a smaller elasticity modulus than the surrounding region.

The switching and combining unit 14 selects an image to be displayed on the image display unit 15 from tomographic image frame data output from the monochromatic scan converter 7, the elasticity image frame data output from the color scan converter 13 and composite image frame data obtained by combining the tomographic image frame data and the elasticity image frame data. Furthermore, the switching and combining unit 14 superimposes and combines the position of the boundary portion specified on the basis of the boundary trace frame data output from the region-of-interest detecting unit 11 on the tomographic image frame data, the elasticity image frame data, and the composite image frame data. The switching and combining unit 14 may display only the boundary portion. The composite image frame data may be displayed so that the tomographic image frame data and the elasticity image frame data may be arranged side by side or the elasticity image frame data is translucently superimposed on the tomographic image frame data. The tomographic image frame data may be a tissue harmonic tomographic image obtained by imaging a harmonic component of a reception signal or a tissue Doppler tomographic image.

The image display unit 15 displays time-series tomographic image frame data obtained by the monochromatic scan converter 7, that is, a tomographic image, time-series elasticity image frame data obtained by the color scan converter 13, that is, an elasticity image, etc., and it includes a D/A converter for converting the tomographic image frame data, the elasticity image frame data, etc. to analog signals and a color television monitor for receiving an analog video signal from the D/A converter and displaying it as an image.

Next, the display style of the image display unit 15 will be described. As shown in FIGS. 3 and 4, the lower limit value X1 and the upper limit value X2 are specified for the histogram data by the operating unit 17 to create boundary trace frame data which extracts the boundary portion of the peripheral edge of the region-of-interest frame data.

Through the switching and combining unit 14, the image display unit 15 displays a boundary portion 30, a boundary portion 34 of the boundary trace frame data on the elasticity image and also displays a boundary portion 32, a boundary portion 36 of the boundary trace frame data on the tomographic image. Accordingly, since the region of the distortion or elasticity modulus of interest is displayed as the boundary portion, the examiner can grasp the inside of the corresponding elasticity image or tomographic image in the boundary portion. By displaying the boundary portion, the examiner can observe the shape of the boundary portion, and determine benignancy, malignancy on the basis of the shape of the boundary portion.

Furthermore, by superimposing and combining the position of the boundary portion on the tomographic image frame data, the examiner can observe a speckle state, a shading state, etc. of the tomographic image in the boundary portion. Furthermore, by superimposing and combining the position of the boundary portion on the elasticity image frame data, the examiner can observe a hue state in the elasticity image.

In this embodiment, the lower limit value X1 and the upper limit value X2 are specified for the histogram data by the operating unit 17 to create the boundary trace frame data extracting the boundary portion of the peripheral edge of the region-of-interest frame data. However, plural upper limit values and lower limit values may be set to extract plural boundary portions and create boundary trace frame data.

### Second Embodiment: Small Region is Set as Being Out-Of-Target

A second embodiment will be described with reference to FIGS. 1, 2 and 6. A different point from the first embodiment resides in that when a region-of-interest to be extracted (region A) is smaller than a threshold value, it is set as an out-of-target of boundary trace frame data.

As in the case of the first embodiment, the boundary detecting unit 112 extracts areas having the distortion or elasticity modulus (elasticity information) corresponding to the range from the lower limit value X1 to the upper limit value X2 from elasticity frame data output from the elasticity information calculating unit 10 to create region-of-interest frame data. “1” is input to areas whose distortion or elasticity modulus (elasticity information) corresponds to the range from the lower limit value X1 to the upper limit value X2, and “0” is input to areas which do not correspond to the range from the lower limit value X1 to the upper limit value X2, thereby creating the region-of-interest frame data.

At this time, when the area or the number of pixels of the region “1” having the distortion or elasticity modulus (elasticity information) corresponding to the range from the lower limit value X1 to the upper limit value X2 of the region-of-interest frame data (region A) is smaller than a threshold value S (for example, 10 points) which the examiner sets in advance, the corresponding region-of-interest (region A) of the region-of-interest frame data is set to “0”. As described above, when the extracted region-of-interest is small, the region-of-interest frame data of the region-of-interest is set to “0”, and thus it is set as an “out-of-target” of the boundary trace frame data. That is, the boundary detecting unit 112 does not detect the boundary portion of the peripheral edge of the region-of-interest (region A) when the area or the number of pixels of the region-of-interest (region A) is smaller than the preset threshold value.

Accordingly, when the region-of-interest to be extracted is small, no boundary trace frame data is created, and thus a boundary portion which is extracted due to noise or the like can be eliminated.

### Third Embodiment: Boundary Portion is Set Outside

A third embodiment will be described with reference to FIGS. 1 to 10. A different point from the first embodiment and the second embodiment resides in that a boundary portion is set by using a smoothing filter.

As shown in FIG. 6, the boundary detecting unit 112 inputs “1” to areas having the distortion or elasticity modulus (elasticity information) corresponding to the range from the lower limit value X1 to the upper limit value X2 (region A), and inputs “0” to areas which do not correspond to the range from the lower limit value X1 to the upper limit value X2 (out of the region A), thereby creating region-of-interest frame data.

The boundary detecting unit 112 applies a smoothing filter to the region-of-interest frame data to create boundary trace frame data. Specifically, the boundary detecting unit 112 counts the number of pixels (area) of “1” contained in a two-dimensional region 24 having a 3×3 kernel size which is set with each pixel of the region-of-interest frame data shown in FIG. 6 set as the center, and divides the number of pixels concerned by the kernel size “9”. The pixel at the left end on first line of the region-of-interest frame data shown in FIG. 6 is set to a pixel (1,1).

Values calculated as described above are shown in FIG. 9. For example, in the case of a pixel (1,1), the number of pixels in the two-dimensional region 24 of the 3×3 kernel size is equal to “0”. When the pixel number “0” is divided by the kernel size “9”, the result is equal to “0”. Furthermore, in the case of a pixel (5,5), the number of pixels in the two-dimensional region 24 of the 3×3 kernel size is equal to “6”. When the number of pixels “9” is divided by the kernel size “9”, the result is equal to “0.66”. In the case of a pixel (7,7), the number of pixels in the two-dimensional region 24 of the 3×3 kernel size is equal to “9”. When the number of pixels “9” is divided by the kernel size “9”, the result is equal to “1”. As described above, the boundary detecting unit 112 performs the calculation for all the pixels of the region-of-interest frame data.

The boundary detecting unit 112 extracts the boundary portion of the peripheral edge of the region which is larger than “0” of the region-of-interest frame data, that is, is formed of values other than “0”. “1” is input to the extracted boundary, and “0” is input to the other regions, thereby creating the boundary trace frame data. As a result, an region B adjacent to the region A is extracted, and boundary trace frame data for which the annular region B serves as the boundary portion are created.

Furthermore, the boundary detecting unit 112 counts the number of “1” contained in a two-dimensional region 26 of 5×5 kernel size which is set with each pixel of the region-of-interest frame data shown in FIG. 6 being set as the center thereof, and divides the number of pixels by the kernel size “25”.

The values calculated as described above are shown in FIG. 10. For example, in the case of a pixel (1,1), the number of pixels in the two-dimensional region 26 of the 5×5 kernel size is equal to “0”. When the number of pixels “0” is divided by the kernel size “25”, the result is equal to “0”. In the case of a pixel (5,5), the number of pixels in the two-dimensional region 26 of the 5×5 kernel size is equal to “13”. When the number of pixels “13” is divided by the kernel size “25”, the result is equal to “0.52”. Furthermore, in the case of a pixel (7,7), the number of pixels in the two-dimensional region 26 of the 5×5 kernel size is equal to “25”. When the number of pixels “25” is divided by the kernel size “25”, the result is equal to “1”. As described above, the boundary detecting unit 112 performs the calculation for all the pixels of the region-of-interest frame data.

The boundary detecting unit 112 extracts the boundary portion of the peripheral edge of the region which is larger than “0” of the region-of-interest frame data, that is, is formed of values other than “0”. “1” is input to the extracted boundary, and “0” is input to the other regions, thereby creating the boundary trace frame data. As a result, the boundary trace frame data for which an annular region C serves as the boundary are created.

The boundary portion of the region B or region C of the boundary trace frame data is set at the outside of the boundary portion of the peripheral edge of the region A which is determined according to the first embodiment. Accordingly, a tomographic image on the boundary portion set according to the first embodiment can be displayed on the image display unit 15. The examiner can minutely observe the speckle state, the shading state, etc. in the tomographic image on the boundary portion set according to the first embodiment.

### Fourth Embodiment: Elasticity Image is Displayed at the Inside or Outside of Boundary

A fourth embodiment will be described with reference to FIGS. 1 to 8. A different point from the first embodiment to the third embodiment resides in that an elasticity image is displayed at the inside of the boundary portion or at the outside of the boundary portion of a tomographic image.

As in the case of the first embodiment, the monochromatic scan converter 7 creates tomographic image frame data, the color scan converter 13 creates elasticity image frame data, and the boundary detecting unit 112 creates boundary trace frame data which extracts the boundary portion of the peripheral edge of the region-of-interest (region A) of the region-of-interest frame data.

The examiner selects through the operating unit 17 that only the tomographic image frame data is displayed inside the boundary portion of the tomographic image frame data or that the elasticity image frame data is translucently displayed inside the boundary portion of the tomographic image frame data while superimposed on the tomographic image frame data.

When the elasticity image frame data is translucently superimposed inside the boundary portion of the tomographic image frame data, the control unit 16 instructs the switching and combining unit 14 to superimpose the boundary portions 32, 36 of the boundary trace frame data on the tomographic image frame data, and also translucently superimpose the tomographic image frame data inside the boundary portions 32, 36 of the tomographic image frame data and the elasticity image frame data. Accordingly, the image display unit 15 can display the elasticity image inside the boundary of the tomographic image.

The image display unit 15 can display an elasticity image outside the boundary portion of the tomographic image. The switching and combining unit 14 superimposes the boundary portions 32, 36 of the boundary trace frame data and the tomographic image frame data, and also translucently superimposes the tomographic image frame data and the elasticity image frame data at the outside of the boundary portion of the tomographic image frame data.

The examiner can minutely observe the speckle state, the shading state, etc. in the tomographic image at the inside of the boundary portion or at the outside of the boundary portion set according to the first embodiment, and also can observe the hardness state in the elasticity image.

### Fifth Embodiment: The Range is Specified with the Peak Set at the Center

A fifth embodiment will be described with reference to FIGS. 1 to 12. A different point from the first to fourth embodiment resides in that the lower limit value X1 and the upper limit value X2 are set on the basis of the peak information of the histogram.

As in the case of the first embodiment, the histogram calculating unit 111 counts the distortion or elasticity modulus (elasticity information) at each coordinate of the elasticity frame data output from the elasticity information calculating unit 10 to calculate histogram data. The histogram data calculated in the histogram calculating unit 111 are displayed on the image display unit 15. The display style of the histogram data displayed on the image display unit 15 is shown in FIGS. 11 and 12.

The boundary detecting unit 112 detects the peak of the histogram output from the histogram calculating unit 111. For example, the boundary detecting unit 112 differentiates the curve of the histogram, and detects as a peak a point at which the differential value is equal to “0” and the gradient varies from “positive” to “negative” (flection point).

As shown in FIG. 11, the control unit 16 sets a range having a predetermined width (for example, 50 kPa) while a detected, for example, peak 1 is set at the center of the range. Then, the control unit 16 sets the minimum value of the set range as the lower limit value X1, and sets the minimum value of the set range as the upper limit value X2. The peak and the range may be arbitrarily selected on an operating table 17.

As in the case of the first embodiment, the boundary detecting unit 112 creates region-of-interest frame data for tracing the corresponding region by using the lower limit value X1 and the upper limit value X2 set as described above, and creates boundary trace frame data. Through the switching and combining unit 14, the image display unit 15 can display a boundary portion 50 of the boundary trace frame data on the elasticity image or display a boundary portion 54 of the boundary trace frame data on the tomographic image.

Here, a region-of-interest 52 is locally contained in the boundary portion 50. The region-of-interest 52 has a lower elasticity modulus than the surrounding region. When the boundary portion of the region-of-interest 52 is required to be displayed, the control unit 16 sets a range having a width (for example, 20 kPa) smaller than the above set predetermined width with a peak 2 smaller than the peak 1 set at the center of the range as shown in FIG. 12. Then, the control unit 16 sets the minimum value of the set range as a lower limit value X1′, and also sets the minimum value of the set range as an upper limit value X2′.

As in the case of the first embodiment, the boundary detecting unit 112 creates region-of-interest frame data for tracing the corresponding region by using the lower limit value X1′ and the upper limit value X2′ specified as described above, and creates boundary trace frame data. Through the switching and combining unit 14, the image display unit 15 can display a boundary portion 56 of the boundary trace frame data on the elasticity image or display a boundary portion 58 of the boundary trace frame data on the tomographic image. Accordingly, the examiner can observe even an minute area of the region-of-interest 52.

### DESCRIPTION OF REFERENCE NUMERALS

1 ultrasonic probe, 2 transmitting unit, 3 receiving unit, 4 ultrasonic wave transmitting/receiving control unit, 5 phasing and adding unit, 6 tomographic image constructing unit, 7 monochromatic scan converter, 8 RF signal frame data selecting unit, 9 displacement measuring unit, 10 elasticity information calculating unit, 11 region-of-interest detecting unit, 111 histogram calculating unit, 112 boundary detecting unit, 12 elasticity image constructing unit, 13 color scan converter, 131 gradation unit, 132 hue converter, 14 switching and combining unit, 15 image display unit, 16 control unit, 17 operating unit

1. An ultrasonic diagnostic apparatus comprising an ultrasonic probe for transmitting/receiving ultrasonic waves to/from an object, a transmitting unit for transmitting ultrasonic waves through the ultrasonic probe, a receiving unit for receiving a reflection echo signal from the object, an elasticity information calculating unit for calculating elasticity information containing distortion or an elasticity modulus on the basis of RF signal frame data based on a reflection echo signal received by the receiving unit, an elasticity image constructing unit for constructing an elasticity image on the basis of elasticity information acquired by the elasticity information calculating unit, a tomographic image constructing unit for constructing a tomographic image on the basis of the RF signal frame data, an image display unit for displaying one or both of the tomographic image and the elasticity image, and a control unit for controlling the respective constituent elements, characterized by further comprising a histogram calculating unit that creates histogram data based on a frequency of the elasticity information, and a boundary detecting unit that detects a boundary portion of a peripheral edge of a region-of-interest set on the basis of a predetermined range of the elasticity information of the histogram data, wherein the image display unit displays the boundary portion.

2. The ultrasonic diagnostic apparatus according to claim 1, characterized in that the image display unit displays the boundary portion on the tomographic image or the elasticity image.

3. The ultrasonic diagnostic apparatus according to claim 1, characterized in that the histogram calculating unit counts a numerical value of elasticity information at each coordinate of elasticity frame data output from the elasticity information calculating unit, and calculates the histogram data on the basis of a frequency of the numerical value.

4. The ultrasonic diagnostic apparatus according to claim 1, characterized in that the boundary detecting unit extracts a region-of-interest of elasticity information corresponding to a predetermined range in the histogram data from the elasticity frame data output from the elasticity information calculating unit, and creates region-of-interest frame data containing the region-of-interest.

5. The ultrasonic diagnostic apparatus according to claim 4, characterized in that the boundary detecting unit creates boundary trace frame data that extracts a boundary portion of a peripheral edge of the region-of-interest of the region-of-interest frame data.

6. The ultrasonic diagnostic apparatus according to claim 5, characterized by further comprising a switching and combining unit that superimposes and combines a position of the boundary portion extracted on the basis of the boundary trace frame data on tomographic image frame data constructed by the tomographic image constructing unit or elasticity image frame data constructed by the elasticity image constructing unit.

7. The ultrasonic diagnostic apparatus according to claim 1, characterized in that the elasticity information is any one of distortion, an elasticity modulus, viscosity, and a Poisson ratio.

8. The ultrasonic diagnostic apparatus according to claim 1, characterized in that the boundary detecting unit does not detect any boundary portion of a peripheral edge of a region-of-interest when the area or the number of pixels of the region-of-interest is smaller than a preset threshold value.

9. The ultrasonic diagnostic apparatus according to claim 1, characterized in that the boundary detecting unit counts the number of pixels of the region-of-interest contained in a two-dimensional region that is set while each pixel of the frame data of the region-of-interest is set as the center of the two-dimensional region, thereby detecting the boundary portion.

10. The ultrasonic diagnostic apparatus according to claim 1, characterized in that the image display unit displays the elasticity image inside or outside the boundary portion.

11. The ultrasonic diagnostic apparatus according to claim 1, characterized in that the boundary detecting unit detects a peak of a histogram output from the histogram calculating unit, and the control unit sets a predetermined range of the elasticity information with the detected peak set at the center of the predetermined range.

12. An ultrasonic image display method comprising: a step of transmitting ultrasonic waves through an ultrasonic probe and receiving a reflection echo signal from an object; a step of calculating elasticity information on the basis of RF signal frame data based on the reflection echo signal; a step of constructing an elasticity image on the basis of the elasticity information; a step of constructing a tomographic image on the basis of the RF signal frame data; a step of displaying one or both of the tomographic image and the elasticity image; a step of creating histogram data based on a frequency of the elasticity information; a step of detecting a boundary portion of a peripheral edge of a region-of-interest set on the basis of a predetermined range of the elasticity information of the histogram data; and a step of displaying the boundary portion.
